(19) United States
(12) Patent Application Publication
(10) Pub. No.: US 2013/0196449 A1
(43) Pub. Date: Aug. 1, 2013

(54) ELECTRICALLY DRIVEN DEVICES FOR SURFACE ENHANCED RAMAN SPECTROSCOPY

(71) Applicant: HEWLETT-PACKARD DEVELOPMENT COMPANY, L.P., Fort Collins, CO (US)

(72) Inventors: Ansoon Kim, Mountain View, CA (US); Huei Pei Kuo, Cupertino, CA (US); Zhiyong Li, Foster City, CA (US); Steven J. Barcelo, Mountain View, CA (US); Zhang-Lin Zhou, Palo Alto, CA (US); Gary Gibson, Palo Alto, CA (US)

(73) Assignee: HEWLETT-PACKARD DEVELOPMENT COMPANY, L.P., Fort Collins, CO (US)

(21) Appl. No.: 13/801,227

(22) Filed: Mar. 13, 2013

Related U.S. Application Data
(63) Continuation-in-part of application No. 13/384,456, filed on Jan. 17, 2012.

(51) Int. Cl. G01N 21/65

(52) U.S. Cl. CPC G01N 21/658
USPC 436/501; 422/69

(57) ABSTRACT

An electrically driven device for surface enhanced Raman spectroscopy includes a substrate, a Raman signal-amplifying structure positioned on the substrate, and an analyte receptor attached to a structure chosen from i) the Raman signal-amplifying structure, or ii) the substrate near the Raman signal-amplifying structure, or iii) combinations of i and ii. The analyte receptor has a selective binding affinity for an analyte. Conductive elements are positioned relative to one another and to the analyte receptor such that the conductive elements together produce an electric field in the vicinity of the analyte receptor when a voltage bias is applied between the conductive elements.

### CROSS-REFERENCE TO RELATED APPLICATIONS

This application is a continuation-in-part of U.S. Ser. No. 13/384,456, entitled “Electrically Driven Devices for Surface Enhanced Raman Spectroscopy”, filed on Jan. 17, 2012, which itself is a U.S. National Stage application under 35 U.S.C. 371 that claims the benefit of International Application Number PCT/US2009/057327 filed on Sep. 17, 2009, both of which are incorporated herein by reference.

### BACKGROUND

Raman spectroscopy is used to study the transitions between molecular energy states when photons interact with molecules, which results in the energy of the scattered photons being shifted. The Raman scattering of a molecule can be seen as two processes. The molecule, which is at a certain energy state, is first excited into another (either virtual or real) energy state by the incident photons, which is ordinarily in the optical frequency domain. The excited molecule then radiates as a dipole source under the influence of the environment in which it sits at a frequency that may be relatively low (i.e., Stokes scattering), or that may be relatively high (i.e., anti-Stokes scattering) compared to the excitation photons. The Raman spectrum of different molecules or matters has characteristic peaks that can be used to identify the species. As such, Raman spectroscopy is a useful technique for a variety of chemical or biological sensing applications. However, the intrinsic Raman scattering process is very inefficient, and rough metal surfaces, various types of nano-antennas, as well as waveguiding structures have been used to enhance the Raman scattering processes (i.e., the excitation and/or radiation process described above). This field is generally known as surface enhanced Raman spectroscopy (SERS).

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a perspective view of an example of an electrically driven device with one of the conductive elements removed for clarity;

FIG. 2A is a cross sectional view, taken along line 2A-2A of FIG. 1, with the additional conductive element and a power source shown;

FIG. 2B is an enlarged view of one of the signal-amplifying structures of FIG. 2A, illustrating an example of a chemical structure of an analyte receptor;

FIGS. 3A through 3C are top views of examples of conductive elements that are suitable for use in the devices disclosed herein;

FIG. 4A is the device of FIG. 2A shown with a couple of electric fields and analyte molecules bound to analyte receptors;

FIG. 4B is an enlarged view of one of the signal-amplifying structures of FIG. 4A, illustrating an example of the chemical structure of bound analyte molecules;

FIG. 5 is a perspective view of an example of a system for surface enhanced Raman spectroscopy including an example of the electrically driven device;

FIG. 6 is a cross-sectional and schematic diagram of an example of a system for surface enhanced Raman spectroscopy including an example of the electrically driven device;

FIG. 7 is a cross-sectional and schematic diagram of an example of a flow through cell having an example of the electrically driven device therein;

FIG. 8 is a perspective view of another example of a flow through cell in which one side is removably sealable with two other sides to enclose the interior portion of the cell;

FIG. 9 is a cross-sectional view of still another example of a flow through cell including an example of the removably sealable one side and a partially optically transparent electrode;

FIG. 10 is a cross-sectional and schematic view of another example of a system for surface enhanced Raman spectroscopy including an example of a flow through cell having an example of the electrically driven device therein;

FIG. 11 is a top schematic view of still another example of a system for surface enhanced Raman spectroscopy including multiple discrete flow through cells;

FIG. 12 is a schematic illustration of multiple electrical connections that may be used in the examples disclosed herein;

FIG. 13 is a graph illustrating the SERS spectra of Cr(VI) on bare nano-fingers and positively charged 4-mercaptopyridinium-functionalized nano-fingers;

FIG. 14 is a graph illustrating the SERS spectra of Cr(VI) on positively charged 4-mercaptopyridinium-functionalized nano-fingers before and after applying an electric field; and

FIG. 15 is a graph illustrating the recyclability of an example of the electrically driven device disclosed herein.

### DETAILED DESCRIPTION

Examples of the electrically driven device disclosed herein include a substrate having a plurality of signal-amplifying structures formed thereof or thereon. Analyte receptors are attached to the signal-amplifying structures and/or to the substrate and near the signal-amplifying structures. The analyte receptors are advantageously capable of reversibly binding analyte molecules (or other materials of interest) so that the electrically driven device may be reused multiple times.

The device(s) disclosed herein also includes conductive elements that produce, under suitable conditions, an electric field that either guides analyte molecules toward or away from the analyte receptors. For example, prior to performing a SERS sensing operation, an applied electric field may generate forces that advantageously concentrate the analyte molecules toward the analyte receptors for binding the analyte molecules to the receptors. The concentration and binding of the analyte molecules amplifies the SERS signal emitted by the analyte molecules. After sensing is performed, another applied electric field may generate forces on the analyte molecules that are sufficient to remove the bound analyte from the analyte receptor. As such, the electrically driven device may be reused multiple times.

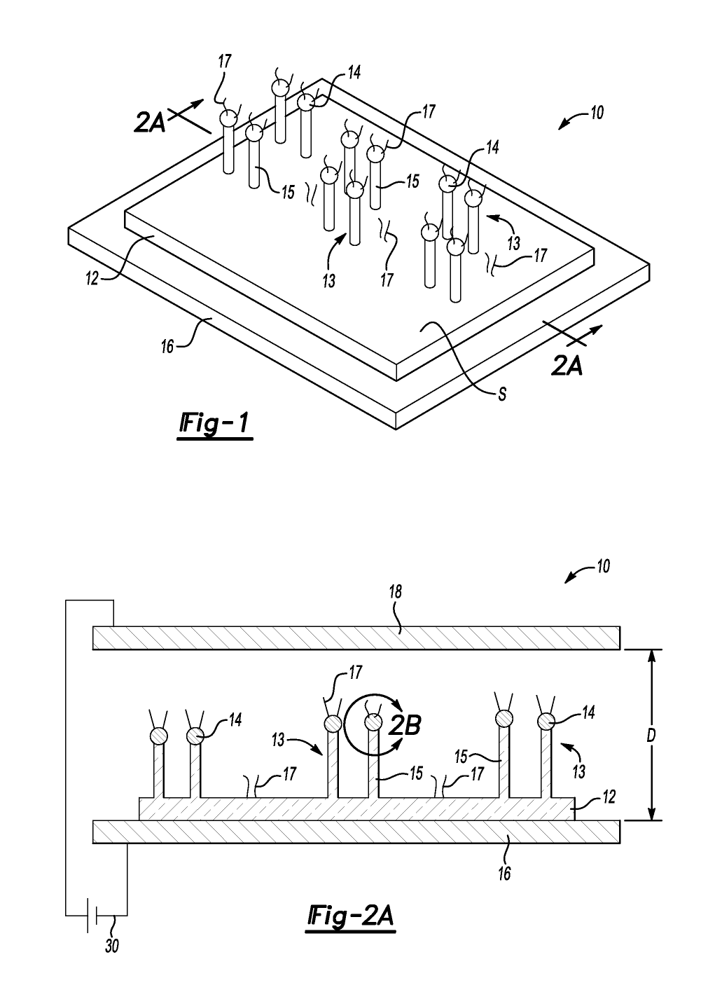

Referring now to FIG. 1, a portion of an example of an electrically driven device 10 is depicted. The device 10 includes a substrate 12. Examples of suitable substrate 12 materials include single crystalline silicon, polymeric materials (acrylics, polycarbonates, polydimethylsiloxane (PDMS), polyimide, etc.), metals (aluminum, copper, stainless steel, alloys, etc.), quartz, ceramic, sapphire, silicon nitride, or glass. The dimensions of the substrate 12 may vary, depending, at least in part, upon the desirable size of the resulting device 10. In instances where the signal-amplifying structures 13 are formed in a surface S of the substrate 12, the dimensions of the substrate 12 may also depend upon the number and depth of the signal-amplifying structures 13 to be formed.

As shown in FIG. 1, the substrate 12 has the signal-amplifying structure(s) 13 positioned thereon. A base portion 15 of the signal-amplifying structure 13 may be integrally formed with the substrate 12 (e.g., via masking and etching, nanoimprinting, etc.). Even though the base portion 15 may be formed integrally with the substrate 12, it is to be understood that the base portion 15 may be formed of the same material as the substrate 12 or of a different material. For example, prior to forming the base portion 15, the substrate 12 may include two layers. The base portion 15 may be formed in the top layer alone so that the resulting base portion 15 and substrate 12 are formed of different materials. For example, the base portion 15 may be composed of a polymeric material, while the substrate 12 is composed of glass, quartz, silicon nitride, metal, or any combination thereof. In other examples, the signal-amplifying structure 13 may be created and then transferred to the substrate 12 (e.g., a polymer substrate, a metal substrate, a quartz substrate, etc.).

The base portion 15 is a high aspect ratio nano-structure that has a length that is at least two times longer than the shortest width. The nano-structure may have an aspect ratio ranging from 2:1 to 20:1, with the aspect ratio being based on the longest dimension to the shortest dimension. Furthermore, the nano-structure has a width or diameter less than 1 μm. Examples of nano-structures include antennas, pillars or nano-wires, poles or rods, flexible columnar or finger-like structures, nanoflake structures, mushroom-shaped nano-structures, cone-shaped structures, multi-faceted structures (e.g., pyramids), etc.

Some examples of the base portion 15 (e.g., pillars, flexible columnar or finger-like structure, etc.) are formed of a compliant material that renders the signal-amplifying structure 13 sufficiently flexible to permit bending so that tips of the structures 13 can meet or be brought in close proximity to one another upon application of a force. Examples of compliant materials include polymers, such as polymethyl methacrylate (PMMA), polycarbonate, siloxane, polydimethylsiloxane (PDMS), photoresists, nanoimprint resists, and other thermoplastic polymers, or UV curable materials that include one or more monomers, oligomers, and/or polymers. Other examples of compliant materials include inorganic materials, such as silicon oxide, silicon, silicon nitride, alumina, diamond, diamond-like carbon, aluminum, copper, and the like. These collapsible base portions are able to undergo self-coalescence (e.g., self-closing at their tips), with the aid of some force (e.g., those forces generated during device operation). The collapsible base portions 15 may be arranged relative to one another in a multi-structure assembly, such as a dimer, a trimer, a tetramer (see FIG. 1), a pentamer, etc. Within these assemblies, a gap exists between the signal-amplifying structures 13. This gap may be reduced upon application of some force, and a hot spot may be formed between the tips of the closed structures 13. In these instances, electromagnetic fields under SERS interrogation are amplified, and uniformity and reliability of hot spot formation is improved. It is believed that application of another force may cause the signal-amplifying structures 13 to revert to their original positions, thereby enlarging the gap.

The base portion 15 may be formed by deep reactive ion etching and passivation. More specifically, the Bosch process may be used, and this process involves a series of alternating cycles of etching (e.g., using SF₆ and O₂ plasmas) and passivation (e.g., using a C₄F₈ plasma). The morphology of the resulting base portion 15 may be controlled by controlling the conditions (e.g., vacuum pressure, RF power, total processing time, individual etching cycle time, individual passivation cycle time, and gas flow rates) of the process. In one example, the etcher is operated at a pressure of 15 mTorr, the coil and platen powers of the etcher are 800 W and 10 W, respectively, each etching cycle (with SF₆ and O₂) is 6 seconds, each passivation cycle (with C₄F₈) is 5 seconds, and the flow rates for SF₆, O₂, and C₄F₈ are 100 sccm, 13 sccm, and 100 sccm, respectively. More generally, the flow rate may be any rate up to about 100 sccm.

In another example, the base portion 15 may be formed using nanoimprinting techniques. For example, a single nanoimprint mold or master (not shown) may be used to form each of the base portions 15. The nanoimprint mold includes a base and a plurality of features formed in a surface of the base. The features of the mold are configured so that when the nanoimprint mold is utilized to imprint the substrate 12, the features define the desired base portions 15. As such, the features of the mold are a negative replica (or the inverse) of the base portions 15. A double molding process may be used to produce a positive replica.

The mold base may be include silica, silicon, quartz, gallium arsenide, or any other suitable metal, ceramic, or polymer material. The features of the mold may be formed in the surface of the mold base by for example, using electron beam lithography, reactive ion etching, or any other wet or dry chemical etching method that results in the formation of a plurality of depressions or grooves in the surface of the mold base. In one example, the mold itself may be formed via the etching and passivation process previously described.

Additionally, a two-generation mastering process may be used to create the mold/master that is the inverse of the substrate 12 having the base portions 15 formed therein. In this example, an initial substrate with base portions formed thereon is created via etching and passivation, and then the mold/master may be formed using this initial substrate.

When the base portions 15 are formed via nanoimprinting, the substrate 12 includes a layer of a deformable material or is a deformable material (e.g., a polymer, such as polymethylmethacrylate (PMMA) or any other commercially available nanoimprint resist material). This deformable substrate material may solidify upon application of energy (such as radiation or heat) thereto. Nanoimprint lithography resists are sold by, for example, Nanonex of Monmouth Junction, N.J. The nanoimprint mold is pressed into the substrate 12 to form corresponding base portions 15 therein. In this example, the imprinted substrate 12 may be cured to solidify the base portions 15, and the nanoimprint mold may be separated from the substrate 12.

Regular or non-regular arrays of the base portions 15 may be formed. The etching and passivation process previously described often results in a non-regular array. It is to be understood that in order to generate a regular array, a fabrication method, such as focused ion-beam, e-beam lithography, optical lithography, or nanoimprint lithography may be used.

As shown in FIG. 1, the base portions 15 have a Raman signal-enhancing material 14 coated thereon. It is to be understood that the phrase “Raman signal-enhancing material” as used herein means a material that, when established on the base portion 15, is capable of increasing the number of Raman scattered photons when the analyte (or other material of interest) is bound to the analyte receptor (reference numeral 17) or is otherwise located proximate to that signal-amplifying structure 13, and when the analyte and material 14 are subjected to electromagnetic radiation. Raman signal-enhancing materials include, for example, silver, gold, copper, platinum, aluminum, palladium, or combinations of these metals in the form of alloys, or multi-layer systems of these metals.

The Raman signal-enhancing material 14 may be established by any suitable deposition or other coating technique. A blanket deposition technique may be used so that the material 14 is established on all of the exposed portions of the surface S of the substrate 12, including the base portions 15. In other examples, a selective deposition technique may be used so that the material 14 is established on, for example, the tips of the bases 15 alone. As examples, the material 14 may be deposited via electron-beam (e-beam) evaporation, sputtering, physical vapor deposition (PVD), chemical vapor deposition (CVD), etc. In still other examples, the signal-enhancing material 18 can be pre-formed nanoparticles (e.g., of silver, gold, copper, etc.), which are coated onto the base portions 15. These nanoparticles may have an average diameter ranging from about 1 nm to about 10 nm. It is believed that the presence of the material 14 in the form of nanoparticles (rather than as a continuous coating of material 14) at the apex of the base 15 further enhances the field during, e.g., a SERS operation. The material 14 itself may also have a surface roughness that spontaneously forms during the deposition process. This surface roughness can act as additional optical antennas to increases the SERS-active sites over each signal-amplifying structure 13.

An analyte receptor 17 may be used to functionalize the signal-amplifying structure 13, the surface S of the substrate 12, or both the signal-amplifying structure 13 and the surface S of the substrate 12. To achieve functionalization, the analyte receptor 17 may be bonded or otherwise permanently attached to the Raman signal-enhancing material 14 of the signal-amplifying structure 13 and/or to the surface S of the substrate 12 at areas around and/or near the signal-amplifying structure 13. To achieve the desired attachment, the analyte receptor 17 that is selected has a very strong binding affinity for the Raman signal-enhancing material 14 that is selected. For example, the analyte receptor 17 may have a thiol group that can bind to a gold Raman signal-enhancing material 14.

The selected analyte receptor 17 is capable of selectively or preferentially binding a desirable analyte. The binding affinity, however, is weaker than a force that is used to release a bound analyte from the analyte receptor 17. As such, the selected analyte receptor 17 is capable of reversibly binding the analyte so that the device 10 may be used multiple times. The analyte receptor 17 may, together with the selected analyte, form what is known in the art as a “specific pair” or a “recognition pair” of molecules. As an example, if the selected analyte is an antigen or an antibody, the analyte receptor 17 may be a complementary antigen or antibody. Many biomolecules act as receptors or ligands to other biomolecules. If the selected analyte is or includes such a biomolecule, the analyte receptor 17 may include a complementary biomolecule.

An example of a suitable analyte receptor 17 includes a positively charged 4-mercaptopyridinium (referred to herein as “+Mpy”). Prior to functionalization, the chemical structure of +Mpy is:

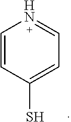

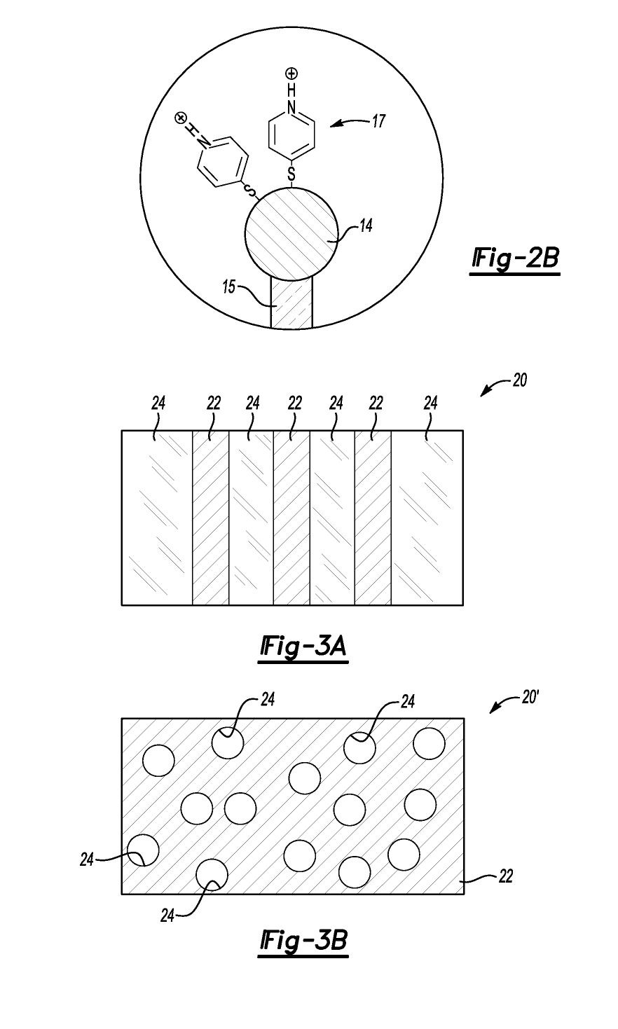

The thiol group of +Mpy may bond to the surface of the Raman signal-enhancing material 14 and/or the substrate 12. An example of +Mpy bonded to the surface of the Raman signal-enhancing material 14 is schematically shown in FIG. 2B. In an example, the thiol group is capable of self-assembling on a gold Raman signal-enhancing material 14. Other examples of suitable analyte receptors include pyridine-like molecules. Examples of pyridine-like molecules have a similar structure as +Mpy, except that the thiol group may be moved to a different position on the pyridine ring and a carbon chain may be added either with the thiol group or as another substituent on the pyridine ring.

Examples of other suitable analyte receptors 17 include cationic amines and carboxylic acids. Suitable cationic amines include positively charged mercaptoalkyl amines, such as positively charged mercaptophenyl amine. Suitable cationic carboxylic acids include positively charged mercaptobenzoic acid and positively charged alkylcarboxylic acids.

Referring now to FIGS. 1 and 2A together, the device 10 further includes two conductive elements 16, 18 (note that conductive element 18 is not shown in FIG. 1 for clarity). In this example, the conductive element 16 is positioned proximate to the substrate 12. Also in this example, the conductive element 18 is positioned relative to the conductive element 16 so that the two conductive element 16, 18 are positioned a desirable distance D (shown in FIG. 2A) from each other. It is to be understood that the enhancement of the electric field at the tips of the signal-amplifying structures 13 may be weakly dependent upon the distance D. A smaller distance D generally creates a larger electric field. Thus, the distance D will depend, at least in part, on the desirable electric field at the tips of the signal-amplifying structures 13.

As shown in FIG. 2A, the signal amplifying structures 13 (including the analyte receptors 17) are positioned between the conductive elements 16, 18. In one example, the substrate 12 may function as the conductive element 16, and so the signal amplifying structures 13 may be positioned directly on the conductive element 16, and the other conductive element 18 may be positioned above the signal amplifying structures 13. The positioning of each of the conductive elements 16, 18 and the structures 13 is such that when an appropriate voltage bias is applied between the conductive elements 16, 18, forces are generated that are able to guide analytes toward the structures 13 or remove bound analytes from analyte receptors 17.

Since SERS applications involve light of a suitable wavelength being directed toward the signal-amplifying structures 13, it is desirable that this example of the conductive element 18, which is positioned over the signal-amplifying structures 13, is at least partially transparent to this light. Examples of suitable transparent conductive materials include indium tin oxide electrodes, Al- and Ga-doped ZnO (AZO and GZO), carbon, or the like. The other conductive element 16 may be transparent or opaque as long as light is not to be transmitted therethrough. Examples of other materials suitable for the conductive elements include metals, such as gold, platinum, aluminum, silver, tungsten, copper, etc.

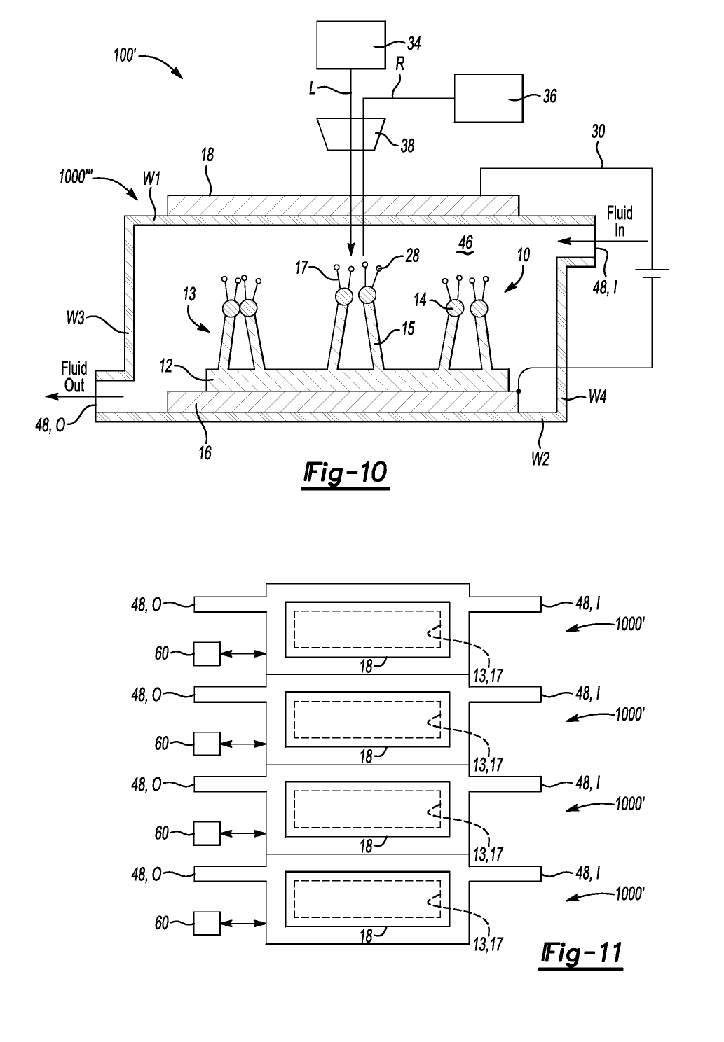

The conductive elements 16, 18 shown in FIG. 2A have rectangular cross-sections, but it is to be understood that conductive elements 16, 18 may also have circular, elliptical, or more complex cross-sections. The conductive elements 16, 18 may also have many different widths or diameters and aspect ratios or eccentricities. Still further, the conductive elements 16, 18 may be hollow electrodes (see, for example, the ring electrode 18, 18′ shown in FIG. 11) and/or plate electrodes.

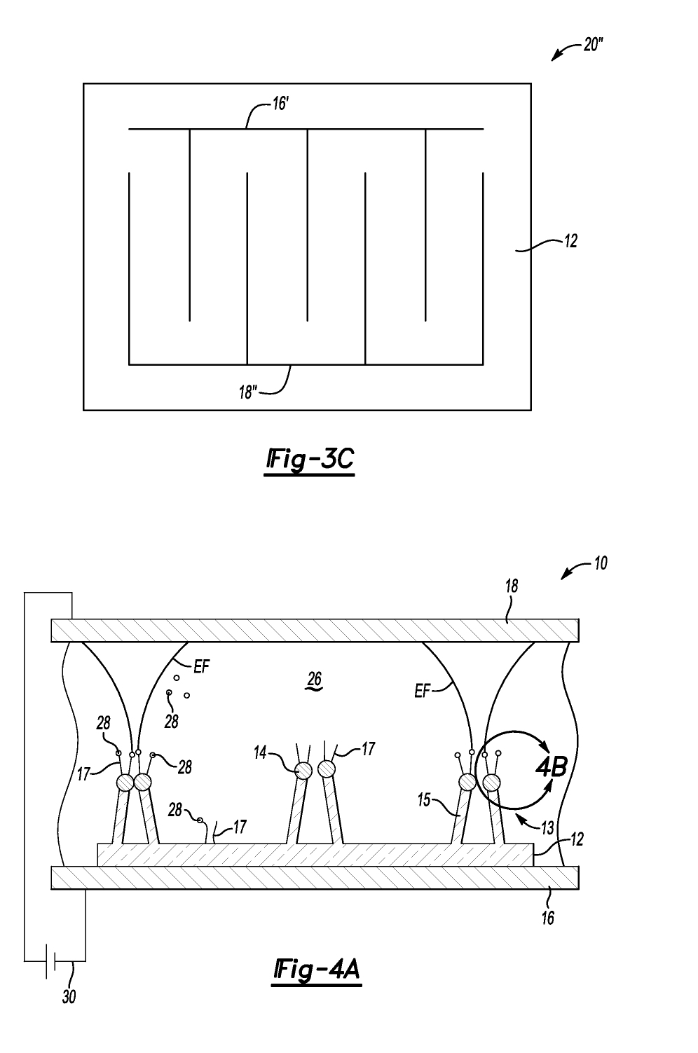

Examples of other conductive elements 20, 20′, 20″ are shown in FIGS. 3A, 3B, and 3C, respectively. The conductive elements 20 and 20′ are partially transparent electrodes that include conductive portions 22 and optically transparent portions 24. The conductive portions 22 may be formed of any suitable conductive material, and the optically transparent portions 24 may be formed of any material that is transparent to the desirable excitation wavelengths and the resulting SERS signals. Conductive elements 20 and 20′ may be particularly suitable alternatives for conductive element 18 shown in FIGS. 1 and 2A.

As shown in FIG. 3A, the conductive element 20 includes conductive parallel or grid lines (i.e., conductive portions 22) formed on and/or between multiple optically transparent portions 24. In this example, the conductive parallel lines are formed of an opaque metal (having a width ranging from about 1 μm to 10 μm) and are spaced at a distance ranging from about 10 μm to about 100 μm. This conductive element 20 may be particularly suitable for instances when the distance D between the conductive elements is greater than the spacing between the conductive lines. As shown in FIG. 3B, the conductive element 20′ includes apertures (i.e., optically transparent portions 24) formed through a conductive material (i.e., conductive portion 22). When apertures are used as the optically transparent portions 24, it is to be understood that they may be left empty (i.e., filled with air) or may be filled with another optically transparent material. The size (e.g., diameter) of each aperture may range from about 10 μm to about 100 μm. Furthermore, the ratio of apertures (i.e., optically transparent portions 24) to conductive portion 22 may range anywhere from 1% to 99%. The configurations of the conductive elements 20, 20′ shown in these Figures allow a fraction of the light introduced thereon to pass through to the underlying substrate 12 via the optically transparent portions 24.

As shown in FIG. 3C, the conductive element 20″ is a substrate 12 that has interdigitated electrodes 16′ and 18″ formed therein or thereon. The substrate 12 may be non-conducting and the interdigitated electrodes 16′, 18″ may be conducting. In an example, conductive element 20″ may be used in place of conductive elements 16, 18.

Any of the conductive elements 16, 18, 20, 20′, 20″ may be acquired in a usable state or may be fabricated using conventional techniques, such as photolithography or electron beam lithography, or by more advanced techniques, such as, e.g., imprint lithography.

It is to be understood that the conductive elements 16, 18, 20, 20′, 20″ may be any suitable size (ranging from a micrometer up to inches), and will depend, at least in part, upon the desirable SERS application for which it is being configured. In one example, the size of each of the conductive elements 16, 18 is comparable to the size of the substrate 12. It is to be understood that since the bottom conductive element 16 in the example of FIGS. 1 and 2A is generally not used for light transmission, it may be thicker than the top conductive element 18.

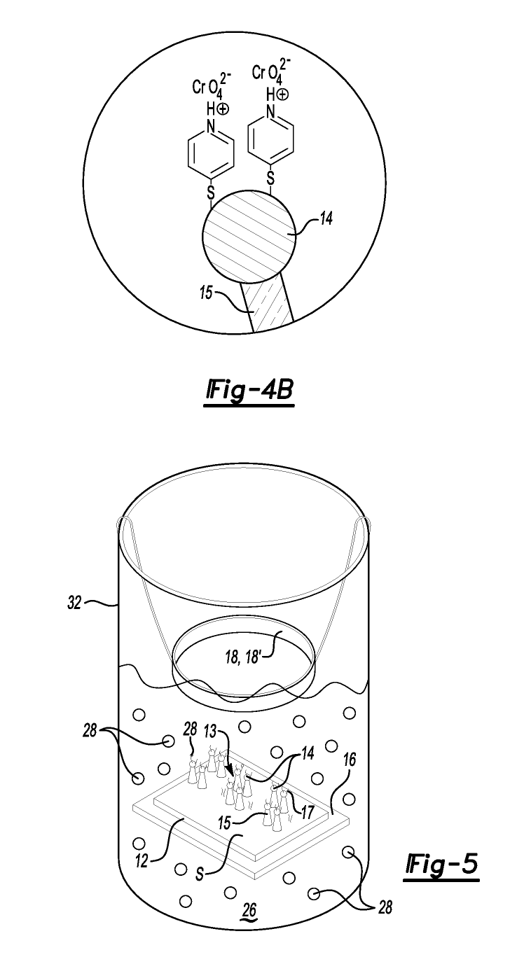

As mentioned hereinabove, an electrical field and forces generated using the conductive elements 16, 18 (or 18′, 18″, 20, 20′, 20″) may be used to guide the analyte molecule (or other material of interest) toward the analyte receptors 17 for binding the analyte molecule to the analyte receptor 17. As an example and as shown in FIG. 4A, during preparation of the device 10 for sensing, the region between the conductive element 18 and the conductive element 16 may be filled with a fluid 26 that contains some concentration of polarizable analyte molecules 28. The fluid 26 is exposed to the signal-amplifying structures 13 and the analyte receptors 17.

The analyte molecules 28 may be molecules that have a permanent charge (e.g., Cr(VI) ions), molecules that have a permanent dipole, or molecules in which a dipole moment case be induced.

Upon application of a voltage bias between the conductive elements 16, 18 using a power source 30, an electric field EF is generated and the analyte molecules 28 in the fluid 26 may be polarized. Forces (e.g., electrophoretic forces if the analyte 28 is charged and/or dielectrophoretic forces if the analyte 28 exhibits appropriate dielectric properties) are imposed on the analyte(s) 28 as a result of the electric field EF and/or gradients in the electric field EF. The force(s) guide the charged and/or polarized analytes 28 toward the analyte receptors 17 for attachment thereto. Application of the field EF during sample preparation increases the speed at which the analyte molecules 28 bind to the analyte receptors 17.

An example of negatively charged chromate ions bound to the +Mpy analyte receptor 17 is shown in FIG. 4B. It is to be understood that if the analyte molecules 28 have a permanent charge, they will experience a net force and be attracted to analyte receptors 17. For the movement of charged particles toward the analyte receptors 17, positively charged molecules 28 require that the conductive element 16 be biased negatively relative to the top conductive element 18, and negatively charged molecules 28 require that the conductive element 16 be biased positively relative to the top conductive element 18. After sensing is performed, the bound analytes 28 may be removed by rinsing with an acidic solution (e.g., hydrochloric acid, sulfuric acid, nitric acid, etc.), or by applying a bias that is the reverse of the bias used to guide the analytes 28 to the receptor 17, by rinsing and applying a reverse bias. When reversed biasing is used, it is to be understood that it is performed so that the force(s) generated is/are stronger than the bond between the analyte 28 and the receptor 17. As such, reversed biasing may be used to release the bound analytes 28 from the analyte receptors 17, thereby preparing the analyte receptors 17 for use in another sensing operation.

Molecules that have a permanent dipole or molecules that are polarizable may be moved using, for example, dielectrophoresis or traveling wave dielectrophoresis as described in U.S. patent application Ser. No. 13/753,796, filed on Jan. 30, 2013 and entitled “Traveling Wave Dielectrophoresis Sensing Device”, which is incorporated herein by reference. A system including two conductive elements 16, 18 as shown in FIG. 4A may be used to create a DC electric field gradient that provides a dielectrophoretic force on a permanent or induced dipole. This may be used to guide the analyte molecules 28 toward the receptors 17. The sign of this force can be reversed by reversing the polarity on the conductive elements 16, 18. Reversing the force may be used to detach the previously bound analyte molecules 28 away from the receptors 17 after sensing has occurred. In the case of traveling wave dielectrophoresis, alternating biases with a first frequency and varying phase may be applied to a set of conductive elements to generate a traveling wave dielectrophoretic force on the analytes 28 in the direction of the analyte receptor 17. After sensing is performed, the direction of the traveling wave dielectrophoretic force may be reversed by applying alternating biases with a second frequency and appropriate phases. The force(s) in the opposite direction will drive bound analytes 28 away from the analyte receptors 17.

The device 10 may also be operated using a DC source and an AC source, which can be separate power sources or a single power source with programmable output voltages. The DC source applies a voltage V_{dc}, while the AC source applies a time varying voltage, such as a sinusoidal voltage, V_{ac}*sin(ft), where f is the frequency of the sinusoidal voltage. The total voltage across the electrochemical cell is V_{dc}+V_{ac}, and this may be used to guide analyte molecules 28 toward the receptors 17. The total voltage may be revered in order to achieve the opposite effect.

Removal of the bound analytes 28 from the receptors 17 using any of the example methods disclosed herein frees the receptors 17 for subsequent binding of other analytes 28 present in different fluids 26. It is believed that the reversibility of the binding enables the device 10 may be used multiple times.

In one example, bendable signal-amplifying structures 13 are pre-collapsed (i.e., the gap between structures 13 is reduced and trapping of analyte molecules 28 between the tips of bendable signal-amplifying structures 13 is blocked). Pre-collapsing the structures 13 may be accomplished after the analyte receptors 17 are functionalized on the Raman signal-enhancing material 14. In these instances, the analyte molecules 28 are bound to the receptors 17 functionalized near (e.g., not between) the touching point of the collapsed signal-amplifying structures 13. Reverse biasing may be used to release the analyte molecules 28 from the analyte receptors 17. It is to be understood that the signals generated in this example may not be as high as instances where the analytes 28 are trapped between the tips and by the receptors 17. In another example, it is believed that the forces used to release bound analytes 28 from the receptors 17 may also be strong enough to move bendable signal-amplifying structures 13 back to their original position (e.g., as shown in FIG. 2A). In these instances, analyte molecules 28 may become trapped i) between the tips of bendable signal-amplifying structures 13 as they collapse and/or ii) by the analyte receptor 17. Reverse biasing may be used to release the analyte molecules 28 from the collapsed structures 13 as well as from the analyte receptors 17.

In still other examples, the analyte molecules 28 may not be removed from the receptor 17. In these examples, the device 10 may still be used multiple times until the receptors 17 are saturated.

FIG. 5 illustrates one example of the assembling of the analyte molecules 28 into the receptors 17. In this example, the substrate 12 and the conductive element 16 are submersed in a fluid 26 containing the analyte molecules 28, which is held in container 32. In this example, a liquid electrolyte is used as the fluid 26. Examples of suitable liquids include water or ethanol.

In this particular example, the conductive element 18 is the previously mentioned hollow conductive element 18′, which is suspended over the substrate 12. It is to be understood that other examples of the conductive element 18, 20, 20″, 20″ may also be used.

While not shown, it is to be understood that the substrate 12 is, in general, electrically connected to the bottom conductive element 16 through a set of low electrical resistance contacts (e.g., a metal region on the top surface of substrate 12 or a metal bottom surface of the substrate 12 if substrate 12 is sufficiently conductive).

The fluid 26 containing the analyte molecules 26 is added into the container 32 to submerse the substrate 12, the bottom conductive element 16, and at least a portion of the top conductive element 18. The power source 30, not shown in FIG. 5, applies a voltage bias between the conductive elements 16, 18 to generate the electric field EF in the region between the electrode 18 and the surface S of the substrate 12. The analyte molecules 28 are attracted by the resulting force(s), and as a result they self-assemble and attach themselves to respective analyte receptors 17 as previously described. After a suitable duration, the substrate 12 and conductive element 16 may be removed from the container 32 for performing the Raman spectroscopy measurement(s). It is to be understood that other methods and mechanisms for guiding and attaching the analyte molecules 28 to the analyte receptors 17 may be used, including a flow through cell described hereinbelow.

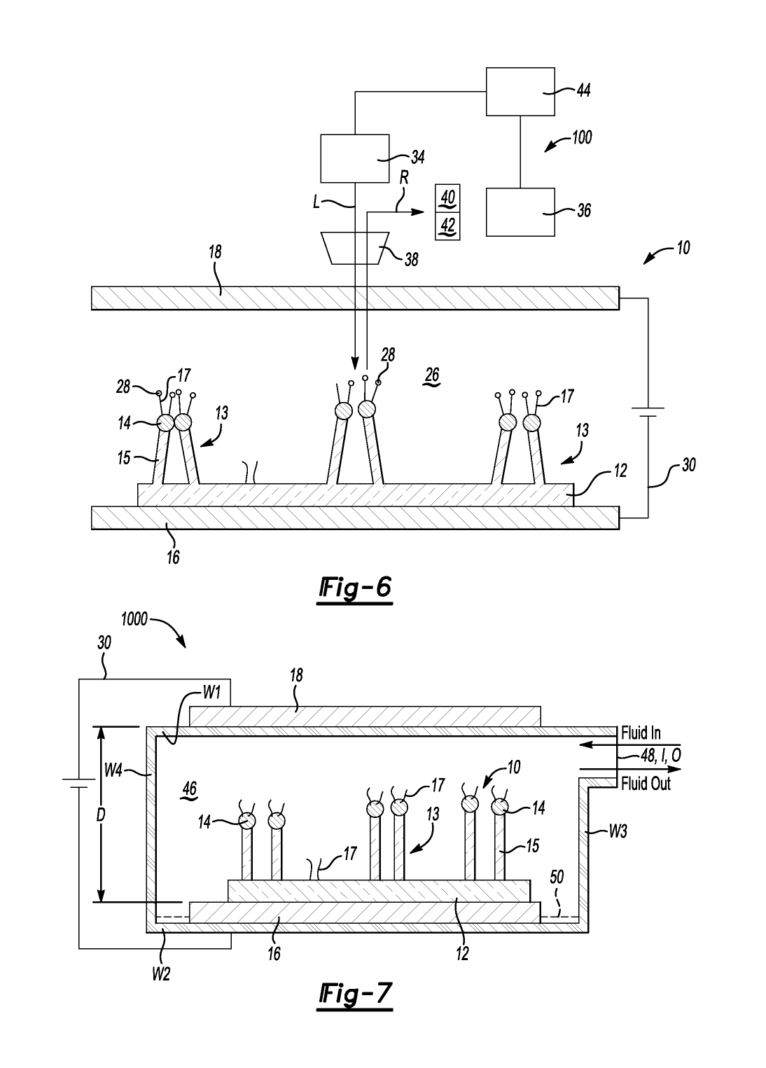

Referring now to FIG. 6, an example of the system 100 for performing both sample preparation and Raman spectroscopy using the device 10 is depicted. The system 100 includes at least the device 10 and a Raman spectrometer or reader, which includes a stimulation/excitation laser source 34 and a photodetector 36. A voltage bias is applied between the conductive elements 16, 18 while a fluid 26 containing the analyte molecules 28 is present in the space above the substrate 12. The voltage bias applied between the substrate 12/bottom conductive element 16 and the top conductive element 18 influences the analyte molecules 28 to attach to the analyte receptors 17, as described earlier.

The analyte molecules 28 and the signal-amplifying structures 13 may be irradiated with electromagnetic radiation (from the laser source 34). The laser source 34 may be a light source that has a narrow spectral line width, and is selected to emit monochromatic light beams L of a suitable wavelength for SERS sensing. Example wavelengths are within the visible range, the ultra-violet range, or the near-infrared range. The laser source 34 may be selected from a steady state laser or a pulsed laser. In one example, the laser source 34 is integrated on a chip. The laser source 34 may also be operatively connected to a power supply (not shown).

The laser source 34 is positioned to project the light L onto the device 10. It is to be understood that the system 100 may, in some examples, also include an optical component 38 (e.g., a lens, an optical microscope), which is positioned between the laser source 34 and the device 10. The optical component 38 focuses the light from the laser source 34 to a desirable area of the substrate 12, and then again collects the Raman scattered light R and passes such scattered light R to the detector 36.

The analyte molecules 28 attached to the receptors 17 and concentrated at or near the SERS signal-amplifying structures 13 interact with and scatter the light/electromagnetic radiation L (note that the scattered light/electromagnetic radiation is labeled R). The interactions between the molecules 28 and the SERS signal-enhancing material 14 of the SERS signal amplifying structures 13 cause an increase in the strength of the Raman scattered radiation R. The Raman scattered radiation R is redirected toward the photodetector 36, which may optically filter out any reflected components and/or Rayleigh components and then detect an intensity of the Raman scattered radiation R for each wavelength near the incident wavelength.

The time for light exposure to achieve SERS measurements may range from 0.5 seconds to about 10 seconds, or more.

A processor 44 may be operatively connected to both the laser source 34 and the photodetector 36 to control both of these components 34, 36. The processor 44 may also receive readings from the photodetector 36 to produce a Raman spectrum readout, the peaks and valleys of which are then utilized for analyzing the analyte molecules 28. While not shown, the Raman reader may also include the previously mentioned power source (e.g., a battery, plug, etc.) and a data I/O (input and output) display. The processor 44 may also be part of a cloud computing system (not shown) to which the laser source 34 and photodetector 36 are wirelessly connected.

The system 100 may also include a light filtering element 40 positioned between the device 10 and the photodetector 36. This light filtering element 40 may be used to optically filter out any Rayleigh components, and/or any of the Raman scattered radiation R that is not of a desired region. The system 100 may also include a light dispersion element 42 positioned between the device 10 and the photodetector 36. The light dispersion element 42 may cause the Raman scattered radiation R to be dispersed at different angles. The elements 40 and 42 may be part of the same device (e.g., the Raman reader) or may be separate devices.

It is to be further understood that if desirable and in some examples, the top conductive element 18 may be removed from the device 10 after sample preparation (i.e., concentration of the analyte molecules 28 at the analyte receptors 17) and prior to Raman spectroscopy measurements.

As previously mentioned, after Raman spectroscopy measurements are taken, the analytes 28 may be removed from the receptors 17 by application of a reverse voltage bias, or some suitable voltage bias that will generate forces in a direction away from the analyte receptors 17.

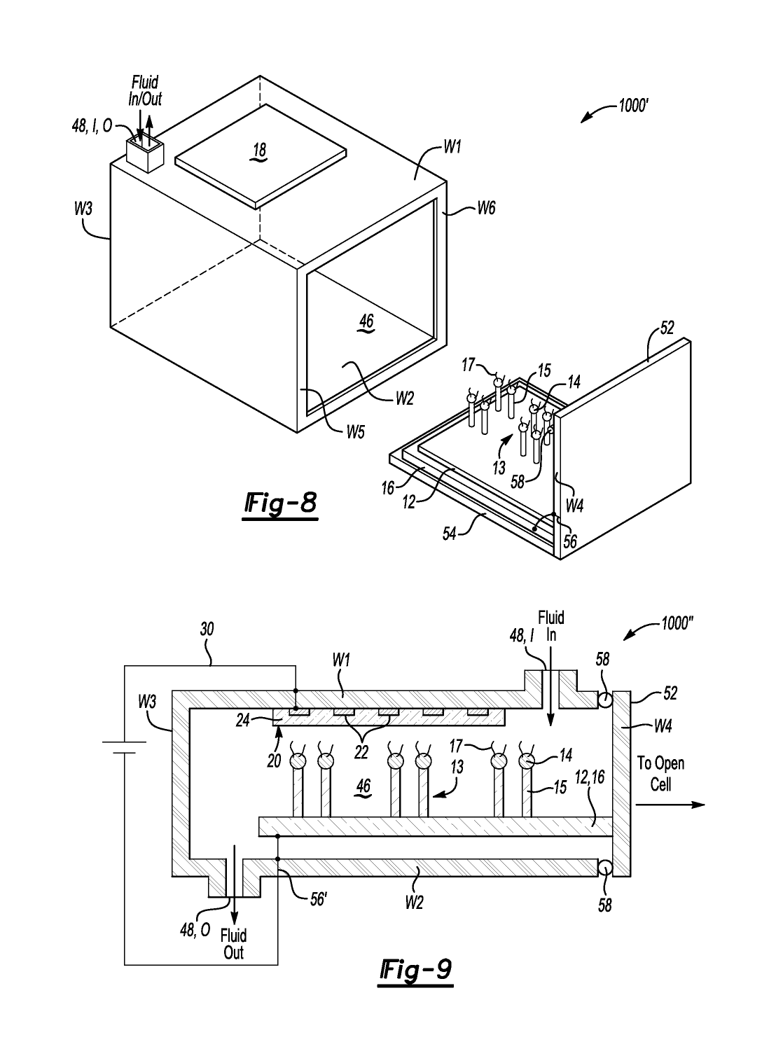

Referring now to FIG. 7, an example of the device 10 is incorporated with a flow through cell 1000. The flow through device 1000 shown in FIG. 7 is a single channel cell including an enclosed interior portion 46 which defines the single channel. The enclosed interior portion 46 itself is defined by at least one surface/wall W₁ that is transparent to light (that will be used for Raman spectroscopy) and another surface/wall W₂ opposed to the at least one transparent surface W₁. In this example, sides walls W₃, W₄ (and W₅, W₆ which are not shown in this view but are shown in FIG. 8) are attached to or formed integrally with each of the surfaces W₁, W₂ to enclose the portion 46. It is to be understood that since light is generally not introduced into the cell 1000 through the wall W₂ or the walls W₃, W₄, W₅, W₆₃ these components may be formed of transparent, semi-transparent, or opaque materials. In particular, any material may be used to form W₂, W₃, W₄, W₅, W₆ as long as such materials do not deleteriously affect the introduction of light into the cell 1000 or the transmission of SERS signals from the cell 1000 through the transparent wall W₁. In one example, the regions of the wall W₁ that faces the laser source 34 (not shown in FIG. 7) are optically smooth (e.g., there is no emission or scattering center on these surfaces and light can pass therethrough without significantly scattering (i.e., d<λ/(8 cos θ), where d is the surface roughness (e.g., root-mean-square roughness height measured from a reference plane), λ is the wavelength of the incident illumination, and θ is the angle of incidence of this illumination). As a non-limiting example, the wall W₁ is formed of quartz or transmissive plastics (e.g., acrylics), and the other walls W₂, W₃, W₄ W₅, and W₆ are formed of quartz, glass, or steel.

The dimensions of the enclosed interior portion 46 will depend, at least in part, upon the desirable dimensions of the substrate 12 that will be positioned therein. As such, the walls W₁, W₂ are spaced apart sufficiently to accommodate the substrate 12 and the signal-amplifying structures 13, including any receptors 17 attached thereto. As a non-limiting example, the total thickness of the cell is the desirable distance D between the conductive elements 16, 18. In one example, the total thickness of the cell 1000 is about 0.5 mm. In another example, the total thickness of the cell 1000 is up to about 5 mm.

As mentioned herein in reference at least to FIG. 2A, the conductive element 18 is at least partially transparent to the light to be used for Raman spectroscopy, and the other conductive element 16 may or may not be transparent. It is to be understood that the conductive elements 16, 18 function in the same manner as described in reference to the operation of the device 10.

As shown in FIG. 7, one of the conductive elements 16 is positioned within the enclosed interior portion 46, and the other conductive element 18 is positioned outside the enclosed interior portion 46. Both conductive elements 16, 18 may be positioned outside of the enclosed interior portion 46. Similarly, both conductive elements 16, 18 may be included within the enclosed interior portion 46. The latter configuration may be more desirable because the conductive elements 16, 18 are physically closer to the substrate 12. In these instances, however, it may be desirable to establish a protective coating (not shown) over the conductive elements 16, 18 in order to reduce the potential for corrosion and/or adsorption of the ions to the conductive elements 16, 18. Examples of the protective coating materials include glass, acrylic, or the like. When used to protect the conductive element 18, it is to be understood that the material selected should be transparent to the excitation wavelengths and Raman signals. The protective coating is generally thin (i.e., less than 100 μm, and in some instances less than 5 nm).

The enclosed interior portion 46 includes at least one port 48 that is configured to introduce fluid (i.e., a liquid containing or acting as a carrier for the analyte molecules 28) into the enclosed interior portion 46 and/or discharge the fluid from the enclosed interior portion 46. In the example shown in FIG. 7, the port 48 is both a fluid inlet I and a fluid outlet O. Since the port 48 allows fluid ingress and egress, it may be fluidly coupled to a reservoir (not shown) which serves as both a sample injector and/or reaction chamber and a waste reservoir.

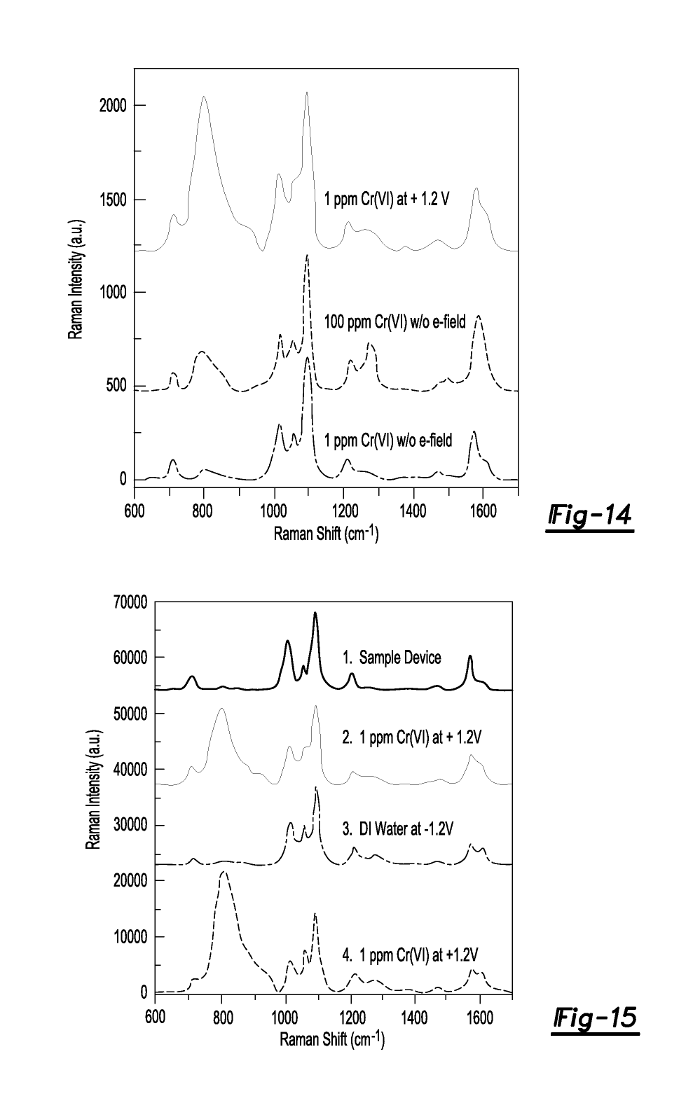

As shown in FIG. 14, the substrate 12 of the electrically driven device 10 is positioned in the enclosed interior portion 46. The substrate 12 includes the signal-amplifying structures 13 and the analyte receptors 17. The materials and methods for forming the signal-amplifying structures 13 and the analyte receptors 17 as described herein may be utilized in this example as well.

As also shown in FIG. 7, the flow through cell 1000 may include a reflective layer 50 deposited on the surface W₂ such that it is positioned within the enclosed interior portion 46. Examples of suitable materials for the reflective layer 50 include metals, such as silver or gold having a thickness less than or equal to 300 nm. A reflective layer 50 may be desirable when a substrate material is selected that is transparent to the wavelengths used during Raman spectroscopy.

Other examples of the flow through cell 1000′, 1000″ are shown in FIGS. 8 and 9. In each of these examples, one of the walls (e.g., wall W₄) is part of a carrier 52, which is detachable from the remaining structure and is removably sealable with walls W₁ and W₂ and with two of the side walls W₅ and W₆ (which are not shown in the cross-sectional view of FIG. 9). Each example of the carrier 52 is moveable between an open position (as shown in FIG. 8) and a closed, sealed position (as shown in FIG. 9).

In these examples, the top and bottom walls W₁, W₂ are similar to those previously described.

The cells 1000′, 1000″ include the substrate exchange carrier 52 which supports the substrate 12 and the bottom conductive element 16. In these examples, the side wall W₄ is part of the carrier 52. As shown in FIG. 8, the carrier 52 includes a support arm 54, upon which the bottom conductive element 16 and substrate 12 may be positioned. In some instances, the support arm 54 also functions as the bottom wall W₂. As shown in FIG. 9, the carrier 52 does not include the support arm 54, but rather the substrate 12 (which, in this example is also the conductive element 16) is mounted to the wall W₄ so that when the carrier 52 is unsealed from the remainder of the cell 1000″, the substrate 12 is removed from the interior portion 46. Either example of the carrier 52 allows i) the substrate 12 and bottom conductive element 16 to be efficiently and easily inserted into and extracted from the interior portion 46, and ii) a seal to be formed when it is in the closed position (e.g., with the assistance of one or more vacuum/fluid sealing mechanisms 58, such as an O-ring, operatively connected to the carrier 52 to seal the enclosed interior portion 46 when the carrier 52 is in the closed position).

Referring now to FIG. 8 alone, the carrier 52 includes an electrical feedthrough 56, which enables a power source 30 (not shown) to be operatively connected to the bottom conductive element 16. The fluid port 48 in this example is shown formed in the wall W₁, but it is to be understood that that the port 48 may be formed in any desirable wall W₁, W₂, W₃, W₄, W₅, or W₆ of the cell 1000′.

Referring now to FIG. 9 alone, an electrical feedthrough 56′ is provided through one of the walls W₂ so that the power source 30 may be operatively connected to the substrate 12/bottom conductive element 16 when the carrier 52 is in the closed and sealed position. It is to be understood that the feedthrough 56′ may be formed in any of the walls W₁, W₂, W₃, W₄, W₅, or W₆, as long as the electrical connection made allows a voltage difference to be applied between the conductive element 18 and the substrate 12/bottom conductive element 16.

As illustrated, this example of the cell 1000″ includes the conductive element 20 (previously described in reference to FIG. 3A) positioned within the enclosed interior portion 46 adjacent to the wall W₁. This type of conductive element 20 provides the desirable electrical connection to be made and the desirable optical effects to be achieved, without having to use 100% conductive or 100% optically transparent materials. Since the conductive element 20 is positioned within the cell 1000″, an electrical feedthrough is provided between the conductive portion(s) 22 of the conductive element 20 and the source 30.

Furthermore, in any of the examples disclosed herein, when the conductivity of the selected substrate 12 is sufficient to act as the conductive element 16, the bottom conductive element 16 may be omitted from the device 10. This is shown in FIG. 9, where the substrate 12 functions as both the substrate 12 in which the base portions 15 are formed and the bottom conductive element 16.

The inlet fluid port 48, I in the example shown in FIG. 9 is shown in the wall W₁, and the outlet fluid port 48, O is shown in the wall W₂. Again, it is to be understood that that the ports 48 may be formed in any desirable wall W₁, W₂, W₃, W₄, W₅, or W₆ of the cell 1000″. Furthermore, during sample preparation, it is to be understood that the port(s) 48, I, O may be sealed with any suitable plug.

Another example of a system 100′ for performing Raman spectroscopy is shown in FIG. 10. This example of the system 100′ includes still another example of the flow through cell 1000′″, which includes a separate fluid inlet 48, I and fluid outlet 48, O. The inlet 48, I may be connected to one or more other devices, such as a sample injector and/or reaction chamber. The analyte molecules 28 may enter the interior portion 46 of the flow through cell 1000′″ and pass across the Raman active substrate 12 (including 13 and 17) in response to generated forces. The analytes 28 bind to the receptors 17, where they may be exposed to stimulating/excitation wavelengths from the laser source 32, and the resulting signals may be detected by the Raman detection unit 36. Even though not shown, it is to be understood that other components (e.g., processor 44) of the Raman spectrometer or reader may be included in this example.

When using any examples of the flow through cell 1000, 1000′, 1000″, 1000′″, it is to be understood that during sample preparation and prior to Raman analysis, the voltage bias may be applied between the conductive elements 16, 18 to concentrate and bind the analyte molecules 28 to the analyte receptors 17. Similarly, after Raman analysis is complete, the reverse voltage bias may be applied between the conductive elements 16, 18 to release the previously bound analyte molecules 28 from the receptors 17 as previously discussed.

It is to be understood that any example of the flow though cell 1000, 1000′, 1000″, 1000′″ may be used with the system 100, 100′ components.

Referring now to FIG. 11, individual flow through cells 1000, 1000′, 1000″, 1000′″ may be coupled together to form a multi-channel microfluidic SERS device. The single channels 1000, 1000′, 1000″, 1000′″ may be assembled so that they are isolated from one another (i.e., have independent inlets 48, I and outlets 48, O) and are fluidly separate (i.e., the fluid in one channel does not mix with or flow to/from another channel). As a result, multiple channels are available for the simultaneous real-time detection of multiple species.

FIG. 11 also schematically depicts an ancillary device 60 operatively connected to each of the individual flow through cells 1000′ in the array. The ancillary device 60 may be selected from a heater (e.g., a resistive heater, an induction heater, etc.), a cooling mechanism, a magnetic field generator, a polarizer, or combinations thereof. One or more of the flow through cells 1000, 1000′, 1000″, 1000′″ in an array may include one or more of such devices 60. These ancillary devices 60 may be particularly useful when the Raman signature of the analyte molecule 28 is dependent upon temperature, magnetic field, polarization of the excitation light, etc. The inclusion of the ancillary device(s) 60 inside or outside of a respective flow through cell 1000, 1000′, 1000″, 1000′″ will depend, at least in part, on the analyte molecule 28 that is to be analyzed.

It is to be understood that any of the examples of the device 10 or flow through cell 1000, 1000′, 1000″, 1000′″ disclosed herein may be fabricated as a portable unit.

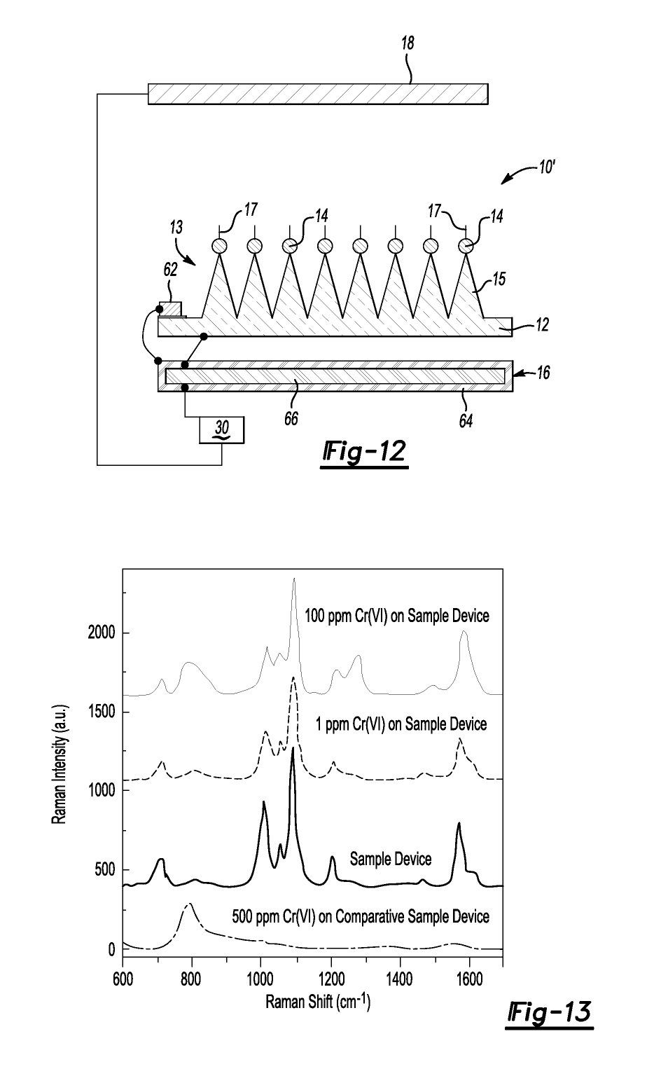

FIG. 12 is a cross-sectional view of the device 10′ illustrating various electrical connections that can be made between the substrate 12, the bottom electrode 16, and/or the source 30. In this example of the device 10′, the signal-amplifying structure 13 includes a cone shaped base portion 15 upon which the Raman signal-enhancing material 14 is deposited.

It is desirable in each of the examples disclosed herein that the substrate 12 be in electrical communication with the bottom conductive element 16 (except of course, when the substrate 12 functions as the bottom conductive element 16). Electrical connection between the substrate 12 and the conductive element 16 can be made via i) a metal contact 62 positioned adjacent a flat portion of the substrate 12 in contact with the material 14, in combination with some mechanism operably connecting the contact 52 to the conductive element 16, ii) the conductive substrate 12 sitting directly on the conductive element 16 (or directly on a conductive layer 64 surrounding an insulator 66, as shown in FIG. 12), or iii) a wire clip operably connecting the substrate 12 to the conductive element 16. While wire clips are shown in FIG. 12, it is to be understood that any other mechanism that enables electrical communication between the substrate 12 and the conductive element 16 may be used (e.g., solder joints). Since wire clips may be used to electrically connect the substrate 12 and the conductive element 16, in some instances, the substrate 12 may be floating in a solution 26 that contains the analyte molecules 28. Electrical connection between the substrate 12 and the conductive element 16 via any path that is electrically conductive or semiconductive.

To further illustrate the present disclosure, examples are given herein. It is to be understood that these examples are provided for illustrative purposes and are not to be construed as limiting the scope of the disclosed example(s).

### EXAMPLES

A Sample device according to the examples disclosed herein was fabricated. Polymer nanofinger structures were fabricated on silicon wafers using nanoimprint lithography (NIL). Gold metal with nominal thickness of about 70 nm was deposited over the polymer nanofingers by e-beam evaporation. For the functionalization, +Mpy diluted in sulfuric acid or ethanol was exposed to the nano-fingers. Unbound +Mpy was rinsed with an acidic solvent.

In the Sample device, the silicon substrate functioned as one of the conductive elements/electrodes.

The electrode having the functionalized nano-fingers thereon was placed into a container and a solution of deionized water and Cr(VI) ions was introduced into the container. Solutions with different concentrations of Cr(VI) ions were tested. The electrode was electrically connected to a counter electrode of platinum via a power source.

For comparative purposes, the same device was made without functionalizing the nano-fingers with +Mpy. The device with bare/non-functionalized nano-fingers is referred to as the Comparative Sample device. This Comparative Sample device was also tested with the solutions.

The first test involved simply applying the solutions to the device without applying any voltage bias. These results are shown in FIG. 13. In particular, FIG. 13 is the SERS spectra that was obtained for a 500 ppm Cr(VI) electrolyte solution exposed to the Comparative Sample device, no electrolyte solution exposed to the Sample device, a 1 ppm Cr(VI) electrolyte solution (pH=1) exposed to the Sample device, and a 100 ppm Cr(VI) electrolyte solution (pH=1) exposed to the Sample device. The Cr(VI) signal appears around 800 cm⁻¹ in the SERS spectra. Compared to the example where no electrolyte solution was exposed to the Sample device, the Cr(VI) signal is observed in the Sample devices when exposed to the 1 ppm and 100 ppm Cr(VI) electrolyte solutions.

A voltage bias of +1.2 V was applied between the electrodes of the Sample device in order to attract CrO₄²⁻ ions to the +Mpy analyte receptors. Surface enhanced Raman spectroscopy data was collected. The Cr(VI) signal was enhanced by 1.5 orders of magnitude, and as shown in FIG. 14, the signal intensity increased for the Sample device exposed to the 1 ppm Cr(VI) electrolyte solution with the electric field more than for the Sample device exposed to 100 ppm Cr(VI) without the electric field.

The reusability of one of the Sample devices was tested. SERS spectra were obtained for the Sample device in the following order: 1) without being exposed to any Cr(VI) ions, 2) after being exposed to a 1 ppm Cr(VI) electrolyte solution (pH=1) and a voltage bias of +1.2V, 3) after being exposed to deionized water and a voltage bias of −1.2V, and 4) after again being exposed to a 1 ppm Cr(VI) electrolyte solution (pH=1) and a voltage bias of +1.2V. These spectra are shown in FIG. 15. After the reverse bias voltage (−1.2V) in deionized water was applied, the Cr(VI) signal seen in spectra 2 disappeared. Subsequently applying +1.2 V in 1 ppm Cr(VI) solution enabled the re-adsorption of Cr(VI) onto the +Mpy analyte receptor.

It is to be understood that the ranges provided herein include the stated range and any value or sub-range within the stated range. For example, a range from about 10 μm to about 100 μm should be interpreted to include not only the explicitly recited limits of about 10 μm to about 100 μm, but also to include individual values, such as 15 μm, 25 μm, 72 μm, etc., and sub-ranges, such as from about 15 μm to about 95 μm, from about 25 μm to about 75 μm, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

What is claimed is:

1. An electrically driven device for surface enhanced Raman spectroscopy, the device comprising:
a substrate;
a Raman signal-amplifying structure positioned on the substrate;
an analyte receptor attached to a structure chosen from i) the Raman signal-amplifying structure, or ii) the substrate near the Raman signal-amplifying structure, or iii) combinations of i and ii, the analyte receptor having a selective binding affinity for an analyte; and
conductive elements positioned relative to one another and to the analyte receptor such that the conductive elements together produce an electric field in the vicinity of the analyte receptor when a voltage bias is applied between the conductive elements.

2. The electrically driven device as defined in claim 1 wherein the analyte receptor is to reversibly bind the analyte.

3. The electrically driven device as defined in claim 2 wherein the selective binding affinity is weaker than a force to release from the analyte receptor the analyte bound thereto.

4. The electrically driven device as defined in claim 3 wherein the force is an electrophoretic force or a dielectrophoretic force.

5. The electrically driven device as defined in claim 1 wherein the analyte receptor is selected from the group consisting of positively charged 4-mercaptopyridinium, cationic mercaptoalkyl amines, and cationic carboxylic acids.

6. The electrically driven device as defined in claim 1, further comprising a fluid disposed adjacent to the Raman signal-amplifying structure, the analyte receptor, and the conductive elements.

7. The electrically driven device as defined in claim 1 wherein:
a first of the conductive elements is integrated in or on the substrate;
a second of the conductive elements is positioned a spaced distance from the first of the conductive elements; and
the signal-amplifying structure and the analyte receptor are positioned between the first and second of the conductive elements.

8. The electrically driven device as defined in claim 1 wherein the Raman signal-amplifying structure is a high aspect ratio nano-structure having a Raman signal-enhancing material coated on at least a portion of the high aspect ratio nano-structure.

9. The electrically driven device as defined in claim 1 wherein the conductive elements are integrated in or on the substrate as interdigitated electrodes.

10. A surface enhanced Raman spectroscopy system, comprising:
an electrically driven device, including:
a substrate;
a Raman signal-amplifying structure positioned on the substrate; an analyte receptor attached to a structure selected from i) the Raman signal-amplifying structure, or ii) the substrate near the Raman signal-amplifying structure, or iii) combinations of i and ii, the analyte receptor having a selective binding affinity for an analyte; and
conductive elements positioned relative to one another and to the analyte receptor such that the conductive elements together produce an electric field in the vicinity of the analyte receptor when a voltage bias is applied between the conductive elements;
a power source operatively connected to the conductive elements to apply the voltage bias between the conductive elements;
a light source operatively positioned to direct light toward the signal-amplifying structure and the analyte receptor; and
a detector operatively positioned to detect an enhanced Raman signal from the analyte bound to the analyte receptor.

11. The surface enhanced Raman spectroscopy system as defined in claim 10 wherein the analyte receptor is to reversibly bind the analyte.

12. The surface enhanced Raman spectroscopy system as defined in claim 10, further comprising a fluid disposed adjacent to the Raman signal-amplifying structure, the analyte receptor, and the conductive elements.

13. The surface enhanced Raman spectroscopy system as defined in claim 12 wherein the fluid includes the analyte, and wherein the analyte is selected from the group consisting of molecules having a permanent charge, molecules having a permanent dipole, and molecules capable of supporting an induced dipole.

14. The surface enhanced Raman spectroscopy system as defined in claim 10 wherein the analyte receptor is selected from the group consisting of positively charged 4-mercaptopyridinium, cationic mercaptoalkyl amines, and cationic carboxylic acids.

15. The surface enhanced Raman spectroscopy system as defined in claim 10 wherein:
a first of the conductive elements is integrated in or on the substrate;
a second of the conductive elements is positioned a spaced distance from the first of the conductive elements; and
the signal-amplifying structure and the analyte receptor are positioned between the first and second of the conductive elements.

16. The surface enhanced Raman spectroscopy system as defined in claim 10 wherein the Raman signal-amplifying structure is a high aspect ratio nano-structure having a Raman signal-enhancing material coated on at least a portion of the high aspect ratio nano-structure.

17. The surface enhanced Raman spectroscopy system as defined in claim 10 wherein the conductive elements are integrated in or on the substrate as interdigitated electrodes.

18. A sensing method, comprising:
exposing an analyte receptor to a fluid including an analyte that selectively binds to the analyte receptor, the analyte receptor being attached to i) a Raman signal-amplifying structure positioned on a substrate, or ii) the substrate near the Raman signal-amplifying structure, or iii) combinations of i and ii;
via conductive elements, generating an electric field that imposes a force on the analyte that guides the analyte to the analyte receptor, thereby binding the analyte to the analyte to the analyte receptor; and
collecting a Raman measurement of the analyte bound to the analyte receptor.

19. The sensing method as defined in claim 18, further comprising generating, via the conductive elements, a second electric field that imposes a second force on the analyte that removes the analyte from the analyte receptor.

20. The sensing method as defined in claim 19 wherein after the analyte is removed from the analyte receptor, the method further comprises:
removing the fluid;
introducing a new fluid including the analyte to the analyte receptor;
via the conductive elements, generating a third electric field that imposes a third force on the analyte that guides the analyte to the analyte receptor, thereby binding the analyte to the analyte to the analyte receptor; and
collecting a Raman measurement of the analyte bound to the analyte receptor.
